(19) United States
(12) Patent Application Publication
(10) Pub. No.: US 2026/0067757 A1
(43) Pub. Date: Mar. 5, 2026

(54) FEEDBACK FOR CONTEXT TRANSFER IN WLANS

(71) Applicant: Samsung Electronics Co., Ltd., Suwon-si (KR)

(72) Inventors: Peshal Nayak, Plano, TX (US); Boon Loong Ng, Plano, TX (US); Bilal Sadiq, Plano, TX (US); Vishnu Vardhan Ratnam, Frisco, TX (US); Yue Qi, Plano, TX (US); Rubayet Shafin, Allen, TX (US)

(21) Appl. No.: 19/291,527

(22) Filed: Aug. 5, 2025

Related U.S. Application Data
(60) Provisional application No. 63/688,146, filed on Aug. 28, 2024.
(60) Provisional application No. 63/690,907, filed on Sep. 5, 2024.
(60) Provisional application No. 63/691,767, filed on Sep. 6, 2024.
(60) Provisional application No. 63/751,939, filed on Jan. 31, 2025.
(60) Provisional application No. 63/802,209, filed on May 8, 2025.

(51) Int. Cl. H04W 36/00; H04W 8/08

(52) U.S. Cl. CPC H04W 36/0033; H04W 8/08

(57) ABSTRACT

Methods and apparatuses for feedback procedures for context transfer in WLANs. A method of wireless communication performed by a station (STA) includes determining to roam from a first access point (AP) to a second AP. The method further includes receiving, from the second AP, context transfer feedback information associated with a context that has been set up with the first AP, the context transfer feedback information indicating information about parameters associated with the context

### CROSS-REFERENCE TO RELATED APPLICATION(S) AND CLAIM OF PRIORITY

This application claims priority under 35 U.S.C. § 119 (e) to U.S. Provisional Patent Application No. 63/688,146, filed on Aug. 28, 2024, U.S. Provisional Patent Application No. 63/690,907, filed on Sep. 5, 2024, U.S. Provisional Patent Application No. 63/691,767, filed on Sep. 6, 2024, U.S. Provisional Patent Application No. 63/751,939, filed on Jan. 31, 2025, and U.S. Provisional Patent Application No. 63/802,209, filed on May 8, 2025, each of which are hereby incorporated by reference in its entirety.

### TECHNICAL FIELD

This disclosure relates generally to wireless communication, and more specifically to feedback procedures for context transfer in Wireless Local Area Networks (WLANs) including next generation WLANs.

### BACKGROUND

Wireless Local Area Network (WLAN) technology allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for feedback procedures for context transfer in WLANs.

In one embodiment, a method of wireless communication performed by a station (STA) includes determining to roam from a first access point (AP) to a second AP. The method further includes receiving, from the second AP, context transfer feedback information associated with a context that has been set up with the first AP, the context transfer feedback information indicating information about parameters associated with the context.

In another embodiment, an AP comprises a transceiver, and a processor operably coupled with the processor. The processor is configured to receive, via the transceiver, an indication that a STA has determined to roam from the first AP to a second AP. The processor is further configured to transmit, via the transceiver, context transfer feedback information associated with a context that has been set up with the STA, the context transfer information indicating information about parameters associated with the context.

In yet another embodiment, a STA comprises: a transceiver, and a processor operably coupled with the transceiver. The processor is configured to: determine to roam from a first AP to a second AP; and receive, via the transceiver, context transfer feedback information associated with a context that has been set up with the first AP, the context transfer feedback information indicating information about parameters associated with the context.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of stages involved during a mobility handover procedure according to embodiments of the present disclosure;

FIG. 5 illustrates an example of a logical AP multi-link device (MLD) according to embodiments of the present disclosure;

FIG. 6 illustrates an example call flow operation for providing feedback prior to roaming according to embodiments of the present disclosure;

FIG. 7 illustrates another example call flow operation for providing feedback prior to roaming according to embodiments of the present disclosure;

FIG. 8 illustrates an example call flow operation for providing feedback at the time of roaming according to embodiments of the present disclosure;

FIG. 9 illustrates another example call flow operation for providing feedback at the time of roaming according to embodiments of the present disclosure;

FIG. 10 illustrates an example call flow operation for providing feedback upon roaming according to embodiments of the present disclosure;

FIG. 11 illustrates another example call flow operation for providing feedback upon roaming according to embodiments of the present disclosure;

FIG. 12 illustrates an example timeline for seamless mobility domain formation between AP1 and a hotspot according to embodiments of the present disclosure; and

FIG. 13 illustrates an example method performed by a STA in a wireless communication system according to embodiments of the present disclosure.

### DETAILED DESCRIPTION

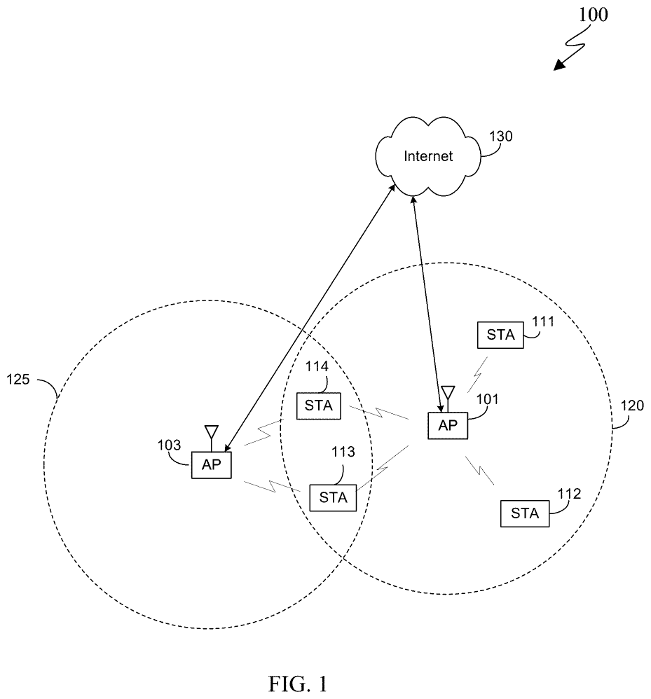

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D3.0, 2023; [2] IEEE Std 802.11-2020.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP” such as “router” or “gateway”. For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA”, such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating feedback procedures for context transfer in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

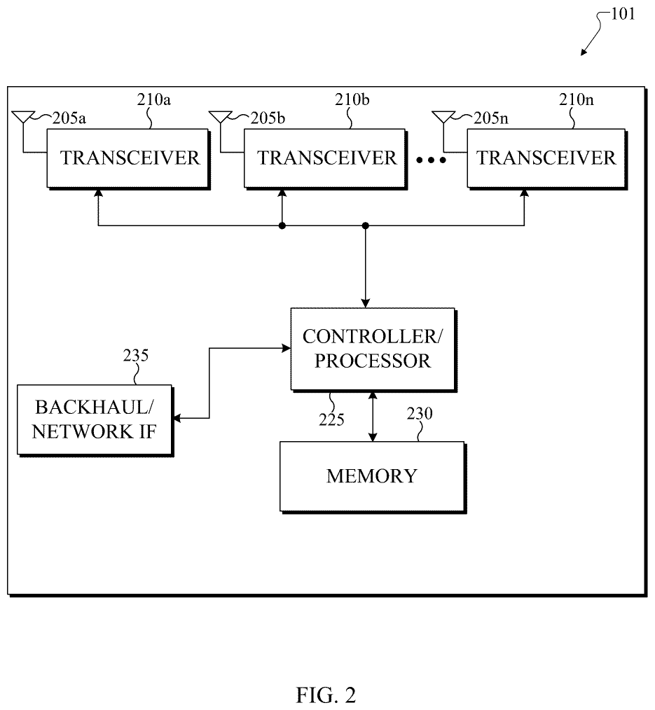

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighed differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating feedback procedures for context transfer in WLANs. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating feedback procedures for context transfer in WLANs. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in legacy APs. Also, various components in FIG. 2 could be combined, further subdivided, or omitted and additional components could be added according to particular needs.

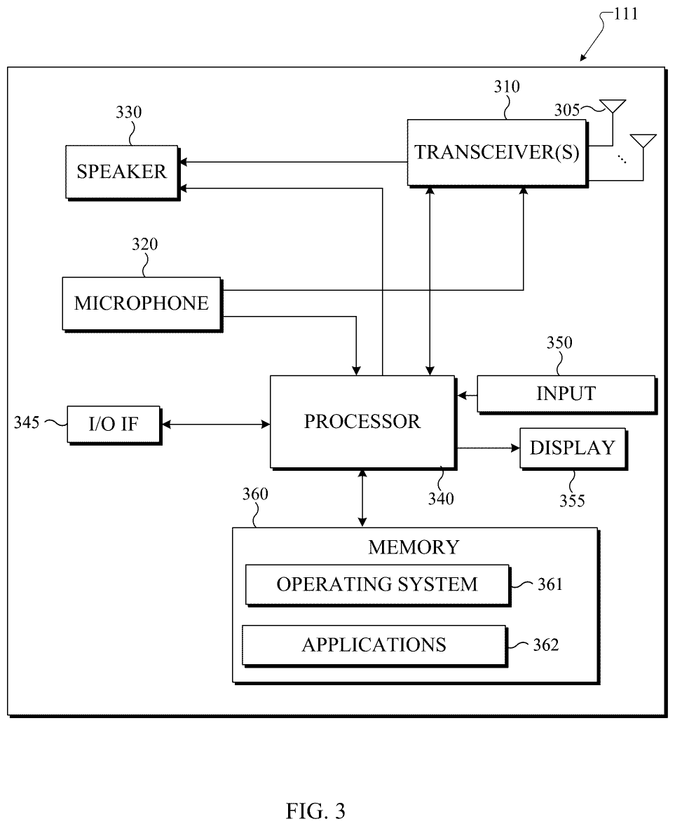

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate feedback procedures for context transfer in WLANs. In some embodiments, the processor 340 includes at least one microprocessor or microcontroller.

The processor 340 is also capable of executing other processes and programs resident in the memory 360, such as operations for facilitating feedback procedures for context transfer in WLANs. The processor 340 can move data into or out of the memory 360 as required by an executing process. In some embodiments, the processor 340 is configured to execute a plurality of applications 362, such as applications for facilitating feedback procedures for context transfer in WLANs. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that as users move around, the signal strength of a station (STA) to its connected access point (AP) can vary. If user movement causes a significant decrease in the signal strength, a handover is necessary. During the process of handover, the STA switches from its current associated AP to a new AP.

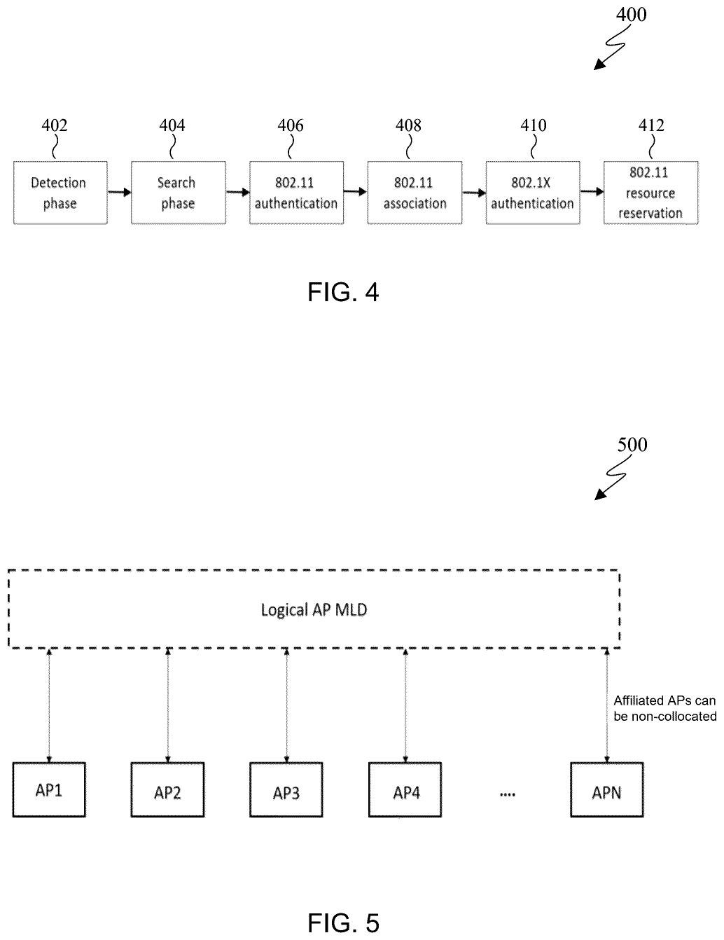

FIG. 4 illustrates an example of stages involved during a mobility handover procedure 400 according to embodiments of the present disclosure. For example, the mobility handover procedure 400 can be performed by any of the STAs 111-114, any of the APs 101, 103, and/or the network 130 of FIG. 1. The embodiment of the example of stages involved during a mobility handover procedure 400 shown in FIG. 4 is for illustration only. Other embodiments of the example of stages involved during a mobility handover procedure 400 could be used without departing from the scope of this disclosure.

As shown in FIG. 4, in legacy devices without any mobility support, the handover procedure involves the following steps:
1. Detection phase: during the detection phase 402, the STA determines that there is a need for a handover, and is typically left to vendor implementation. For example, a particular vendor implementation can choose to trigger handover when the signal strength to the currently associated AP drops below a certain threshold.
2. Search phase: the detection phase 402 is followed by a search phase 404. During the search phase 404, the STA searches for new APs to associate with. During the search phase 404, the STA performs a scan of different channels to identify APs in the vicinity. This can be done either passively (e.g., listening to beacons on a particular channel) or actively (e.g., by the use of probe request and response procedures). Passive scan can take a lot of time as the scanning STA needs to wait on each channel for a sufficient amount of time to ensure that the beacon is received from APs on that channel. Since each AP transmits beacons after a certain period of time (e.g., 100 ms), passive scan can consume a lot of time. In the case of active scan, the STA transmits a probe request and waits for a probe response from APs in the vicinity. Without prior knowledge of APs in the vicinity, active scan can take several seconds to complete.
3. 802.11 authentication: after the scanning procedure is complete, the next step is to perform 802.11 authentication 406 (open system/shared key based), where the STA establishes its identity with the AP.
4. 802.11 association: Once the STA is authenticated, the next step is to perform association 408.
5. 802.1X authentication: Introduced in IEEE 802.1i amendment, the 802.1X authentication phase 410 comprises an EAP authentication between the STA and a AAA server with the assistance of the AP.
6. 802.11 resource reservation: Finally, in the 802.11 resource reservation phase 812, the STA sets up various resources at the new AP. For example, the STA can perform QoS reservation, BA setup, etc. with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In order to reduce the handover delay, a number of procedures have been introduced in several standards. The focus of these procedures is to remove/reduce the delay encountered in various steps of the handover procedure. In 2008, IEEE 802.11r introduced a fast transition roaming which eliminates the need for the authentication step 406 (step 3 above) during the handover. In 2011, IEEE 802.11k introduced assisted roaming which reduces the search phase 404 (step 2 above) by allowing the STA to request the AP to send channel information of candidate neighbor APs. In 2011, IEEE 802.11v also introduced network assisted roaming to assist the search phase 404. In IEEE 802.11be, the fast BSS transition procedure was extended to cover the case of MLO operation. This procedure helps to reduce the delays encountered due to 802.11 resource reservation (step 6 above). However, the STA still needs to perform the association and authentication phases which can take 10 s of ms.

### Roaming Procedures for Bridge Mode AP

A mode of operation known as bridge mode enables a user to add another AP to the network. This AP can be added by forming a wired bridge with the existing AP. In a wired bridge, the two APs are wired to each other via their WLAN ports. The DHCP on the second AP is disabled and as a result, the STA can carry its IP lease as it roams from the first AP to the second AP. The two APs can also be connected to each other via a wireless bridge. Further, a mobile device can also be connected to the AP via a wireless bridge and can serve as an extension of the main AP.

FIG. 5 illustrates an example of a logical AP multi-link device (MLD) 500 according to embodiments of the present disclosure. For example, the logical MLD device 500 can be made up of multiple APs, including any of the APs 101, 103 of FIG. 1. The embodiment of the logical MLD device 500 shown in FIG. 5 is for illustration only. Other embodiments of the logical MLD device 500 could be used without departing from the scope of this disclosure.

### A. Feedback Procedures for Context Transfer

Embodiments of the present disclosure recognize that in next generation WLANs, a target for low-latency with high reliability support can be targeted. In order to meet this goal, the concept of a logical AP MLD can be considered. As depicted in FIG. 5, a logical AP MLD can be made up of several APs which can be non-collocated. This is different from the concept of AP MLD in IEEE 802.11be which considers collocated APs affiliated with an AP MLD.

As depicted in FIG. 5, AP 1 to AP N can be non-collocated. Further, one or more of these APs can have a common data path to a router or a central controller. The APs shown in FIG. 5 can form a logical AP MLD. This new concept of AP MLD is expected to reduce the delays of association and authentication steps mentioned above as the STA may not need to perform association and authentication during handover.

In some embodiments, logical AP MLD can imply any kind of connection between physical APs to enable coordination amongst them. Example connections between physical APs can include roaming AP MLD, non-collocated AP MLD, SMD, etc.

Before a STA roams from its current AP to a target AP, the STA may have setup multiple features at the current AP (see examples in Table 1 below).

TABLE 1
Examples of contexts that may be setup with the current AP.

| Context | Type |
|---|---|
| Sequence Number (SN) | Dynamic |
| Packet Number (PN) | Dynamic |
| Block ACK (BA) parameters (e.g., SN) | Dynamic |
| Security keys (e.g., PTKs, GTKs, etc.) | Near Static |
| BA setup | Near Static |
| SCS/MSCS | Near Static |
| EPCS | Near Static |
| TWT and variants (rTWT, bTWT, individual | Near Static |
| TWT, etc.) | |
| P2P TWT/CoEx Sessions | Near Static |
| Power Save: Dynamic SMPS, UPSD, WNM, | Near Static |
| Intra PPDU PS, etc. | |
| EMLSR setup | Near Static |
| EMLMR setup | Near Static |
| PHY Capabilities | Near Static |

Thus, a context transfer may be necessary to ensure that the STA does not have to re-setup the context again at the target AP. However, the current AP may not be able to transfer all the contexts to the target AP when the STA roams. Parameters for some features such as SCS, TWT, etc. may not be accepted by the target AP and the target AP may require the STA to re-negotiate them again after roam. However, the STA needs to be aware of which contexts have been transferred and which ones need to be re-negotiated again at the target AP.

One or more of the above features may require that the STA should receive feedback from the candidate target/target AP about the context. For example, in the case of EPCS, the STA may need an enhanced EDCA parameter set to use upon roaming to the candidate target/target AP, in the case of SN/PN, the candidate target/target AP may not be able to accept the parameters and may provide new values to the STA to use upon roam, for SCS the candidate target/target AP may need to suggest an acceptable delay bound to the STA, etc.

To perform efficient context transfer, the STA may need to receive feedback from the candidate target/target AP and procedure to enable this is needed.

### B. Traffic Load Assessment for Roaming

In the current specification, when a STA wants to roam from one AP to another, the STA can obtain BSS load and available admission capacity information when performing AP selection. A STA may have a certain QoS requirement and BSS load may not be sufficient for the STA's decision. For example, the STA may have voice traffic and may prefer to roam to an AP where the voice traffic queue is lightly loaded. However, it is not possible for a STA to obtain this information from the AP based on the current signaling. Procedures to enable a STA to obtain this information is needed.

### C. Roaming Procedures for Bridge Mode AP

The present disclosure defines two APs-a main AP and a secondary AP which is coupled to the main AP via a wireless/wired bridge mode. When a STA roams from the main AP to the secondary AP, the STA can be required to perform a layer 2 roam. This can be disruptive and can affect the performance of the application running on the STA. A seamless roam can be beneficial. Procedures that enable such a seamless roam setup are important.

Accordingly, embodiments of the present disclosure provide mechanisms for enabling feedback transmission from candidate target/target AP to STA, including: (i) feedback procedures; (ii) feedback prior to roaming; (iii) feedback at the time of roaming; (iv) feedback upon roaming; and (v) signaling using multi-link reconfiguration procedure.

Further, embodiments of the present disclosure provide mechanisms for advertising detailed traffic level load information, including: (i) per traffic type load message; (ii) procedures for advertisement of the information; and (iii) procedures for request of the information.

Further, embodiments of the present disclosure provide mechanisms for handling a seamless roaming between a main AP and a secondary AP, including: (i) seamless mobility domain formation; and (ii) advertisement procedures.

### A. Feedback Procedures for Context Transfer

### 1. Feedback Procedures

According to some embodiments, during context transfer, a feedback message can be provided to the STA. The feedback message can contain at least one or more of the information items as indicated in Table 2.

TABLE 2
Information items that can be indicated in a feedback message

| Information | |
|---|---|
| items | Description |
| Operation | One or more information item(s) that can describe one or |
| parameters | more operation parameters associated with the feature that |
| | the STA may need to set upon roaming. E.g., enhanced |
| | EDCA parameter set in the case of EPCS, updated SN/PN, |
| | etc. |
| Suggested | One or more information item(s) that can describe the |
| parameters | suggested parameters for the feature that the candidate |
| | target/target AP(s) can accept upon roaming. E.g., |
| | suggested delay bounds, service periods, updated SN/PN, |
| | etc. This can enable a faster convergence for the STA |
| | upon roaming as it can start to make requests with the |
| | suggested parameters. |
| Deadline | One or more information item(s) that can describe a |
| information | deadline by which the above information can be |
| | considered as valid. Beyond this deadline, the above |
| | information may need to be fetched again from the |
| | candidate target/target AP. The deadline can be per |
| | operation/suggested parameter per feature per |
| | candidate target/target AP or there can be one deadline |
| | overall. |
| Reason | One or more information item(s) that can describe the |
| information | reason for the parameter generation. E.g., a reason code |
| | explaining why the suggested parameters are different |
| | from the ones that the STA has setup with the current AP. |
| AP | One or more information item(s) that can indicate the |
| indicator | candidate target/target AP to which this information |
| | corresponds to. E.g., AP's BSSID. |

The above feedback can be per candidate target/target AP.

### STA Side Behavior:

When context transfer is initiated, the STA can expect to receive such a feedback from the candidate target/target AP. When the STA receives such a feedback, the STA could use the operation parameters if it decided to roam to the candidate/target AP or upon roaming to the candidate target/target AP if the STA has already decided to roam. The STA can process the suggested parameters to decide if it can accept them or not.

The above information can enable the STA to choose a target AP out of a candidate AP set if the procedures are completed prior to roaming.

### Current AP Behavior:

The current AP can perform necessary steps for context transfer and receive the above feedback from the candidate target/target AP. The current AP can compile the feedback and generate a feedback message and transmit the message to the STA.

### Candidate Target/Target AP Behavior:

The candidate target/target AP can perform necessary steps for context transfer, process the current/proposed parameters from the STA and generate a response with the feedback message. The feedback message can be sent to the current AP and/or to the STA upon roam.

### 2. Feedback Prior to Roaming:

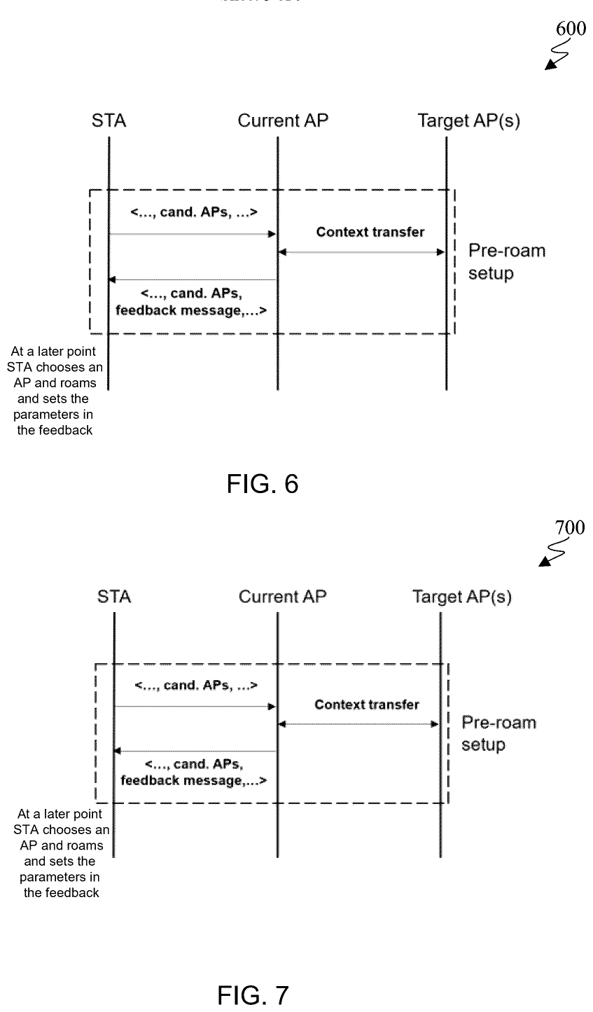

FIG. 6 illustrates an example call flow operation 600 for providing feedback prior to roaming according to embodiments of the present disclosure. The call flow operation 600 of FIG. 6 can be performed by any of the STAs 111-114 of FIG. 1, such as the STA 111 of FIG. 3, and any of the APs 101, 103 of FIG. 1. The embodiment of the call flow operation 600 shown in FIG. 6 is for illustration only. Other embodiments of the call flow operation 600 could be used without departing from the scope of this disclosure.

FIG. 7 illustrates another example call flow operation 700 for providing feedback prior to roaming according to embodiments of the present disclosure. The call flow operation 700 of FIG. 7 can be performed by any of the STAs 111-114 of FIG. 1, such as the STA 111 of FIG. 3, and any of the APs 101, 103 of FIG. 1. The embodiment of the call flow operation 700 shown in FIG. 7 is for illustration only. Other embodiments of the call flow operation 700 could be used without departing from the scope of this disclosure.

According to some embodiments, as illustrated in FIGS. 6 and 7, the feedback message can be provided to the STA during a pre-roam setup phase. The pre-roam setup phase can refer to a preparation phase. The operation parameters can enable the STA to set the appropriate parameters at the time of roaming for operation with the target AP. The feedback can also enable the STA to understand what parameters it can suggest to the target AP (if selected) when setting up the other features again with the target AP or to understand what parameters the target AP can support. This feedback can also be useful as one of the AP selection parameters.

### 3. Feedback at Time of Roaming:

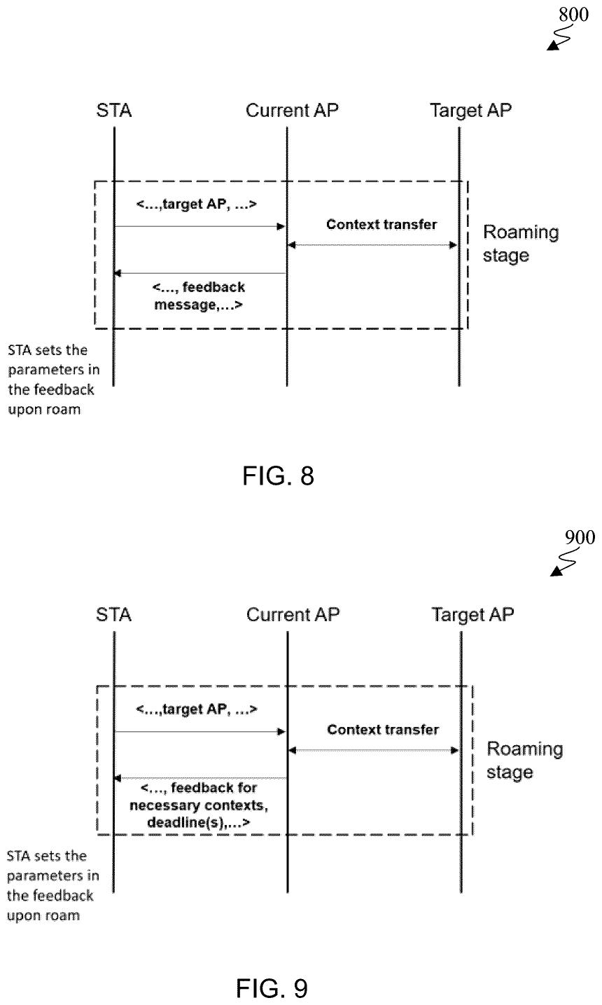

FIG. 8 illustrates an example call flow operation 800 for providing feedback at the time of roaming according to embodiments of the present disclosure. The call flow operation 800 of FIG. 8 can be performed by any of the STAs 111-114 of FIG. 1, such as the STA 111 of FIG. 3, and any of the APs 101, 103 of FIG. 1. The embodiment of the call flow operation 800 shown in FIG. 8 is for illustration only. Other embodiments of the call flow operation 800 could be used without departing from the scope of this disclosure.

FIG. 9 illustrates another example call flow operation 900 for providing feedback at the time of roaming according to embodiments of the present disclosure. The call flow operation 900 of FIG. 9 can be performed by any of the STAs 111-114 of FIG. 1, such as the STA 111 of FIG. 3, and any of the APs 101, 103 of FIG. 1. The embodiment of the call flow operation 900 shown in FIG. 9 is for illustration only. Other embodiments of the call flow operation 900 could be used without departing from the scope of this disclosure.

According to some embodiments, as illustrated in FIGS. 8 and 9, the feedback can also be provided at the time of roaming. The roaming stage can refer to an execution/transition phase. This can enable the STA to set appropriate parameters upon roam to communicate with the target AP. The STA can also understand what parameters are acceptable for the features that it can need to setup with the target AP.

### 4. Feedback Upon Roaming:

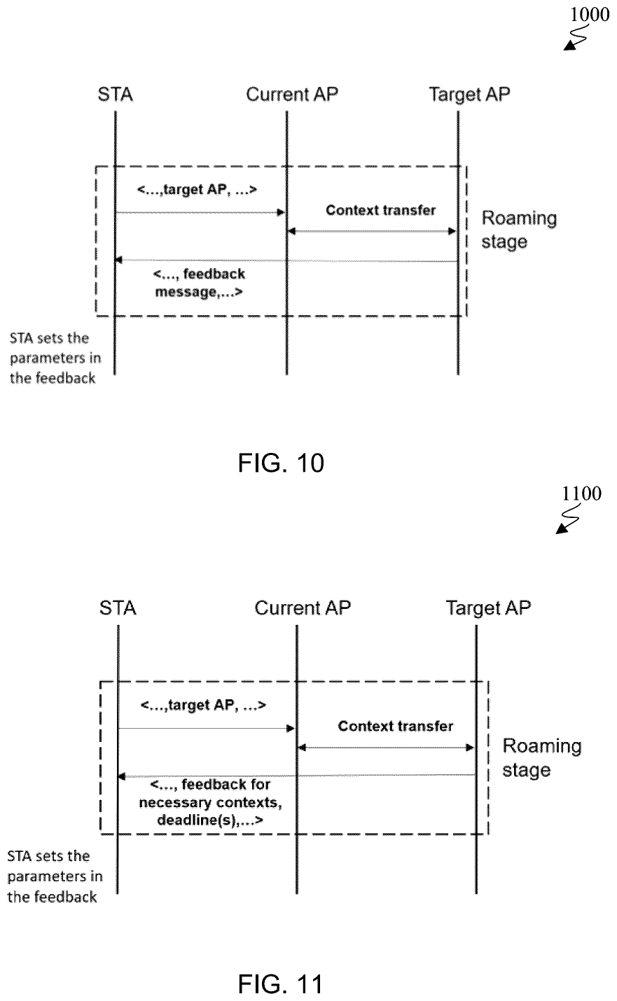

FIG. 10 illustrates an example call flow operation 1000 for providing feedback upon roaming according to embodiments of the present disclosure. The call flow operation 1000 of FIG. 10 can be performed by any of the STAs 111-114 of FIG. 1, such as the STA 111 of FIG. 3, and any of the APs 101, 103 of FIG. 1. The embodiment of the call flow operation 1000 shown in FIG. 10 is for illustration only. Other embodiments of the call flow operation 1000 could be used without departing from the scope of this disclosure.

FIG. 11 illustrates another example call flow operation 1100 for providing feedback upon roaming according to embodiments of the present disclosure. The call flow operation 1100 of FIG. 11 can be performed by any of the STAs 111-114 of FIG. 1, such as the STA 111 of FIG. 3, and any of the APs 101, 103 of FIG. 1. The embodiment of the call flow operation 1100 shown in FIG. 11 is for illustration only. Other embodiments of the call flow operation 1100 could be used without departing from the scope of this disclosure.

According to some embodiments, as illustrated in FIGS. 10 and 11, the feedback can also be provided upon roaming. For example, if after initiating roaming, the STA goes outside the range of the target AP but has received an ACK for its roaming initiation message, the STA can switch to the target AP's channel and the target AP can send the feedback to the STA. In some embodiments, the feedback information can be provided as a part of a preparation or execution/transition phase performed with the second AP directly over-the-air.

The above procedures can be used for any type of roaming architecture for example, SMD, non-collocated AP MLD, FT based roaming, etc.

The different notifications and response can have an acknowledgement (ACK) procedure succeeding them.

### 5. Signaling Using Multi-Link Reconfiguration Procedure:

According to some embodiments, the feedback message can be carried in a multi-link reconfiguration response frame. The modified multi-link reconfiguration response frame can have an example format as shown in Table 3.

TABLE 3
Example link reconfiguration response frame
action field format. Order can be different.

| Order | Meaning |
|---|---|
| 1 | Category |
| 2 | Protected EHT/UHR Action |
| 3 | Dialog Token |
| 4 | Operation parameters |
| 5 | Reason code |
| 6 | Suggested parameters |
| 7 | Deadline |
| 8 | Count |
| 9 | Reconfiguration Status List |
| 10 | Group Key Data (optional) |
| 11 | OCI element (optional) |
| 12 | Basic Multi-link element |
| | (optional) |

### Operation Parameters:

The operation parameters can carry the operation parameters for each of the features/setup/contexts that have been transferred successfully to the target AP MLD. An example operation parameters field can be as shown in Table 4.

TABLE 4
Example operation parameters field. The field can contain
one or more information items for each of the features grouped
together in a single field/element/individual elements

| Information | |
|---|---|
| item | Example |
| SCS | One or more SCS descriptor elements that contain the |
| parameters | information corresponding to the operation of SCS at the |
| | new target AP MLD. Optional parameters in the SCS |
| | descriptor element that are not necessary to describe the |
| | operation parameters of SCS transferred to the new target |
| | AP MLD may not be present. E.g., An SCS descriptor |
| | element that can contain a QoS characteristic element that |
| | can indicate a service start time and service start time |
| | link ID corresponding to an SCSID indicated in the SCS |
| | descriptor element. |
| EPCS | EPCS priority access multi-link element carrying the an |
| parameters | EDCA and a MU EDCA parameter set element. |
| | Alternatively, the elements can be present separately |
| | with a separate indication that they correspond to EPCS |
| | operation and not to normal EDCA and MU EDCA |
| | operation. |
| BA (block | One or more BA agreements or parameters associated with |
| ACK) | those BA agreements. |
| agreements | |
| MSCS | One or more tuples of MSCS descriptor elements and UP |
| parameters | that contains information corresponding to the |
| | operation of MSCS at the target AP MLD. |

When the non-AP MLD receives the operation parameters from the current AP MLD, the non-AP MLD can use the parameters after it roams to the target AP MLD.

### Reason Code:

The reason code can be a list of reason code corresponding to each feature.

### Suggested Parameters:

The suggested parameters can carry the suggested parameters for each of the features that were rejected. An example can be as shown in Table 5.

TABLE 5
Example suggested parameters field. The field can contain one or more
information items for each of the features that are suggested

| Information | |
|---|---|
| item | Example |
| SCS | One or more SCS descriptor elements that contain the |
| parameters | information on the SCS parameters that are acceptable at |
| | the target AP MLD. E.g., the delay bound. |

### Deadline:

The deadline can be a deadline to roam to the target AP MLD for the setup to hold true.

### B. Traffic Load Assessment for Roaming

### 1. Per Traffic Type Load Message

According to some embodiments, the STA can be provided with a per traffic type load message. The traffic type here can refer to the access category (AC) or to the TID level information. The message can contain at least one or more of the information items as shown in Table 6.

TABLE 6
Information items that can be present
in the per traffic type load message

| Information | |
|---|---|
| item | Description |
| Per AC load | One or more information item(s) that can indicate |
| | a per AC level load information. |
| Per AC channel | One or more information item(s) that can indicate |
| utilization | a per AC channel utilization. |
| Per TID load | One or more information item(s) that can provide |
| | a per TID level load information. |
| Per TID channel | One or more information item(s) that can provide |
| utilization | a per TID level channel utilization. |
| Per AC queuing | One or more information item(s) that can provide |
| delay | a per AC level queuing delay. |
| Per TID queuing | One or more information item(s) that can provide |
| delay | a per TID level queuing delay. |
| Number of STAs | One or more information item(s) that can indicate |
| per AC | the number of STAs that have traffic streams for |
| | each AC. |
| Number of STAs | One or more information item(s) that can indicate |
| per TID | the number of STAs that have traffic streams for |
| | each TID. |
| Per STA per AC | One or more information item(s) that can indicate |
| load | the per STA per AC load level. |
| Per STA per TID | One or more information item(s) that can indicate |
| load | the per STA per TID load level. |
| Per STA per AC | One or more information item(s) that can indicate |
| channel utilization | the per STA per AC channel utilization. |
| Per STA per TID | One or more information item(s) that can indicate |
| channel utilization | the per STA per TID channel utilization. |
| Per AC | One or more information item(s) that can indicate |
| available | the per AC available admission capacity. In one |
| admission | example, the admission capacity can be the |
| capacity | remaining amount of medium time available via |
| | explicit admission control. This information item |
| | can enable a STA to select an AP that is likely |
| | to accept a future admission control request in |
| | a particular AC. |
| Per TID | One or more information item(s) that can indicate |
| available | the per TID available admission capacity. In one |
| admission | example, the admission capacity can be the |
| capacity | remaining amount of medium time available via |
| | explicit admission control. This information item |
| | can enable a STA to select an AP that is likely |
| | to accept a future admission control request |
| | in a particular TID. |

In one example, the above information items can be present in an element.

### 2. Advertisement of the Information

The above information item can be advertised by the AP. For example, the AP can include the above information in its beacons and probe response frames.

The STAs that receive such information can use the information for AP selection purposes.

The above information can also be advertised for one AP by another AP. For example, if AP1 and AP2 form an SMD, AP1 can advertise the above information for AP2.

### 3. Request of the Information

The above information can also be requested by the STA. For example, the STA can transmit a request message to request the above information from its current AP or from a target AP. The AP can send the above information in response to the request message.

### C. Roaming Procedures for Bridge Mode AP

### 1. Seamless Mobility Domain Formation

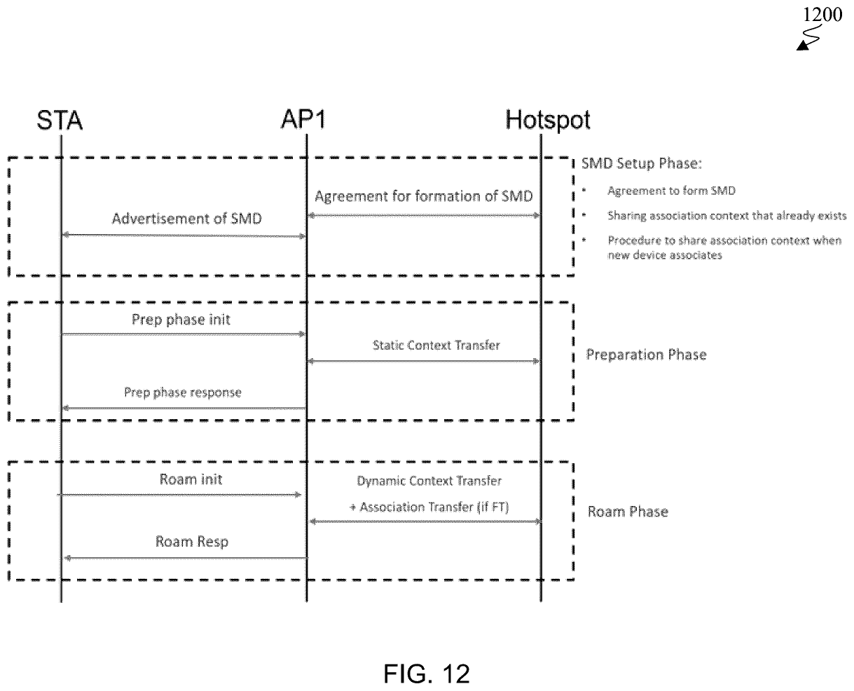

FIG. 12 illustrates an example timeline 1200 for seamless mobility domain formation between AP1 and a hotspot according to embodiments of the present disclosure. The embodiment of the timeline 1200 shown in FIG. 12 is for illustration only. Other embodiments of the timeline 1200 could be used without departing from the scope of this disclosure.

As illustrated in FIG. 12, according to some embodiments, a seamless mobility domain setup phase can be considered. The phase can involve the secondary and the main AP to form a seamless mobility domain with each other.

In the setup, an initiator can send a SMD formation request message to an AP. The AP which receives the SMD formation request message can respond with an SMD formation response message. Upon agreement, the two APs can coordinate with each other for enabling a seamless roaming for their associated STAs.

According to some embodiments, the association context for a STA can be exchanged over the wireless link between the main AP and the secondary AP.

### 2. Advertisement

When a main AP and a secondary AP form an SMD, they can advertise the presence of the SMD to their associated STAs. The STAs that receive the advertisement message can then initiate the seamless roam procedures during roam.

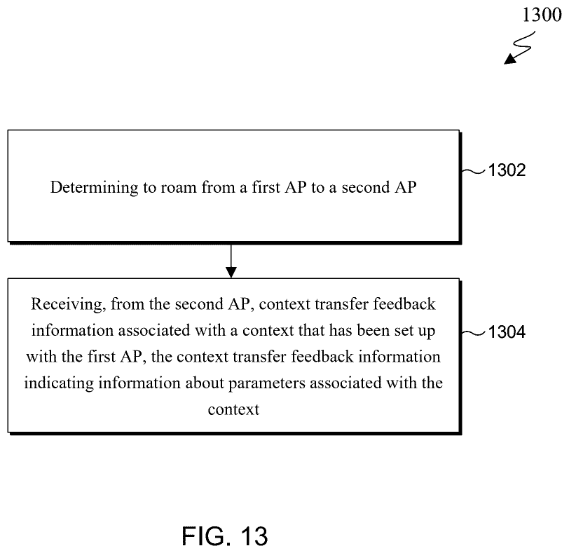

FIG. 13 illustrates an example method 1300 performed by a STA in a wireless communication system according to embodiments of the present disclosure. The method 1300 of FIG. 13 can be performed by any of the STAs 111-114 of FIG. 1, such as the STA 111 of FIG. 3. The method 1300 is for illustration only and other embodiments can be used without departing from the scope of the present disclosure.

As illustrated in FIG. 13, the method 1300 begins at step 1302, where the STA determines to roam from a first AP to a second AP. At step 1304, the STA receives, from the second AP, context transfer feedback information associated with a context that has been set up with the first AP, the context transfer feedback information indicating information about parameters associated with the context.

In some embodiments, the information about parameters associated with the context includes at least one of: an information item that describes an operation parameter associated with a feature that the STA needs to set upon roaming; an information item that describes suggested parameters for a feature that the second AP can accept upon roaming; an information item that describes a deadline by which the information about the parameters is considered as valid; an information item that describes a reason for generation of the parameters associated with the context; or an information item that indicates a target AP to which the information corresponds.

For example, in some embodiments, an operation parameter associated with a feature that the STA needs to set upon roaming can be an enhanced distributed channel access (EDCA) parameter set in the case of an emergency preparedness communication service (EPCS). In some embodiments, an information item that describes suggested parameters for a feature that the second AP can accept upon roaming can be associated with suggested delay bounds, service periods, or an updated serial number or part number. In some embodiments, an information item that describes a deadline by which the information about the parameters is considered as valid can be per operation/suggested parameter per feature per candidate target/target AP, or there can be one deadline overall. In some embodiments, an information item that describes a reason for generation of the parameters associated with the context can be a reason code explaining why the suggested parameters are different from the ones that the STA has setup with the current AP. In some embodiments, an information item that indicates a target AP to which the information corresponds can be an AP's basic service set identifier (BSSID).

In some embodiments, the information about parameters associated with the context includes an information item that describes an operation parameter associated with a feature that the STA needs to set upon roaming; and the information item comprises at least one of: an element associated with a stream classification service (SCS) that contains information corresponding to an operation of SCS at the second AP; an element associated with an emergency preparedness communication service (EPCS) that contains information corresponding to an operation of EPCS at the second AP; an element associated with a mirrored stream classification service (MSCS) that contains information corresponding to an operation of MSCS at the second AP; or an element associated with block acknowledgement (BA) that contains information corresponding to an operation of BA at the second AP.

In some embodiments, the STA receives the context transfer feedback information prior to roaming to the second AP. In some embodiments, the feedback message can be provided to the STA during a pre-roam setup phase. The pre-roam setup phase can refer to a preparation phase.

In some embodiments, the STA receives the context transfer feedback information at time of roaming to the second AP. The roaming stage can refer to an execution/transition phase.

In some embodiments, the STA receives the context transfer feedback information upon roaming to the second AP. For example, if after initiating roaming, the STA goes outside the range of the target AP but has received an ACK for its roaming initiation message, the STA can switch to the target AP's channel and the target AP can send the feedback to the STA.

In some embodiments, the STA receives the context transfer feedback information via a link reconfiguration frame. In some embodiments, the link reconfiguration frame can have an example format as shown in Table 3.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a station (STA), the method comprising:
determining to roam from a first access point (AP) to a second AP; and
receiving, from the second AP, context transfer feedback information associated with a context that has been set up with the first AP, the context transfer feedback information indicating information about parameters associated with the context.

2. The method of claim 1, wherein the information about parameters associated with the context includes at least one of:
an information item that describes an operation parameter associated with a feature that the STA needs to set upon roaming;
an information item that describes suggested parameters for a feature that the second AP can accept upon roaming;
an information item that describes a deadline by which the information about the parameters is considered as valid;
an information item that describes a reason for generation of the parameters associated with the context; or
an information item that indicates a target AP to which the information corresponds.

3. The method of claim 2, wherein:
the information about parameters associated with the context includes an information item that describes an operation parameter associated with a feature that the STA needs to set upon roaming; and
the information item comprises at least one of:
an element associated with a stream classification service (SCS) that contains information corresponding to an operation of SCS at the second AP;
an element associated with an emergency preparedness communication service (EPCS) that contains information corresponding to an operation of EPCS at the second AP;
an element associated with a mirrored stream classification service (MSCS) that contains information corresponding to an operation of MSCS at the second AP; or
an element associated with block acknowledgement (BA) that contains information corresponding to an operation of BA at the second AP.

4. The method of claim 1, further comprising receiving the context transfer feedback information prior to roaming to the second AP.

5. The method of claim 1, further comprising receiving the context transfer feedback information at time of roaming to the second AP.

6. The method of claim 1, further comprising receiving the context transfer feedback information upon roaming to the second AP.

7. The method of claim 1, further comprising receiving the context transfer feedback information via a link reconfiguration frame.

8. A first access point (AP) comprising:
a transceiver; and
a processor operably coupled with the transceiver, the processor configured to:
receive, via the transceiver, an indication that a station (STA) has determined to roam from the first AP to a second AP; and
transmit, via the transceiver, context transfer feedback information associated with a context that has been set up with the STA, the context transfer feedback information indicating information about parameters associated with the context.

9. The first AP of claim 8, wherein the information about parameters associated with the context includes at least one of:
an information item that describes an operation parameter associated with a feature that the STA needs to set upon roaming;
an information item that describes suggested parameters for a feature that the second AP can accept upon roaming;
an information item that describes a deadline by which the information about the parameters is considered as valid;
an information item that describes a reason for generation of the parameters associated with the context; or
an information item that indicates a target AP to which the information corresponds.

10. The first AP of claim 9, wherein:
the information about parameters associated with the context includes an information item that describes an operation parameter associated with a feature that the STA needs to set upon roaming; and
the information item comprises at least one of:
an element associated with a stream classification service (SCS) that contains information corresponding to an operation of SCS at the second AP;
an element associated with an emergency preparedness communication service (EPCS) that contains information corresponding to an operation of EPCS at the second AP;
an element associated with a mirrored stream classification service (MSCS) that contains information corresponding to an operation of MSCS at the second AP; or
an element associated with block acknowledgement (BA) that contains information corresponding to an operation of BA at the second AP.

11. The first AP of claim 8, wherein the processor is further configured to transmit, via the transceiver, the context transfer feedback information to the STA prior to roaming to the second AP.

12. The first AP of claim 8, wherein the processor is further configured to:
transmit, via the transceiver, the context transfer feedback information to the STA at time of roaming to the second AP; or
transmit, via the transceiver, the context transfer feedback information to the STA upon roaming to the second AP.

13. The first AP of claim 8, wherein the processor is further configured to transmit, via the transceiver, the context transfer feedback information to the STA via a link reconfiguration frame.

14. A station (STA) comprising:
a transceiver; and
a processor operably coupled with the transceiver, the processor configured to:
determine to roam from a first access point (AP) to a second AP; and
receive, via the transceiver, context transfer feedback information associated with a context that has been set up with the first AP, the context transfer feedback information indicating information about parameters associated with the context.

15. The STA of claim 14, wherein the information about parameters associated with the context includes at least one of:
an information item that describes an operation parameter associated with a feature that the STA needs to set upon roaming;
an information item that describes suggested parameters for a feature that the second AP can accept upon roaming;
an information item that describes a deadline by which the information about the parameters is considered as valid;
an information item that describes a reason for generation of the parameters associated with the context; or
an information item that indicates a target AP to which the information corresponds.

16. The STA of claim 15, wherein:
the information about parameters associated with the context includes an information item that describes an operation parameter associated with a feature that the STA needs to set upon roaming; and
the information item comprises at least one of:
an element associated with a stream classification service (SCS) that contains information corresponding to an operation of SCS at the second AP;
an element associated with an emergency preparedness communication service (EPCS) that contains information corresponding to an operation of EPCS at the second AP;
an element associated with a mirrored stream classification service (MSCS) that contains information corresponding to an operation of MSCS at the second AP; or
an element associated with block acknowledgement (BA) that contains information corresponding to an operation of BA at the second AP.

17. The STA of claim 14, wherein the processor is further configured to transmit, via the transceiver, the context transfer feedback information to the STA prior to roaming to the second AP.

18. The STA of claim 14, wherein the processor is further configured to transmit, via the transceiver, the context transfer feedback information to the STA at time of roaming to the second AP.

19. The STA of claim 14, wherein the processor is further configured to transmit, via the transceiver, the context transfer feedback information to the STA upon roaming to the second AP.

20. The STA of claim 14, wherein the processor is further configured to transmit, via the transceiver, the context transfer feedback information to the STA via a link reconfiguration frame.
